(19) United States
(12) Patent Application Publication
(10) Pub. No.: US 2017/0214238 A1
(43) Pub. Date: Jul. 27, 2017

(54) Programmable Fuse With Under-voltage/short-circuit Protection

(71) Applicant: Oceaneering International, Inc., Houston, TX (US)

(72) Inventors: Aaron Christopher Klijn, Austin, TX (US); Greg Robert Boyle, Camarillo, CA (US); David Robert Pereverzoff, Houston, TX (US)

(73) Assignee: Oceaneering International, Inc., Houston, TX (US)

(21) Appl. No.: 14/952,171

(22) Filed: Nov. 25, 2015

(51) Int. Cl. H02H 3/24; H02H 3/00

(52) U.S. Cl. CPC H02H 3/24; H02H 3/006

(57) ABSTRACT

A programmable fuse system provides under-voltage/short-circuit protection, and comprises an electrical circuit sensor operatively in communication with a predetermined set of electrical circuits; a controller operatively in communication with the electrical circuit sensor, the controller comprising active logic, memory, and data representing a set of characteristic current/trip time curves; and one or more programmable fuses operative to completely disconnect a predetermined electrical circuit of the set of electrical circuits on detection of a fault, without the need to replace a programmable fuse and without reliance on any small current to maintain its protection, and to remain completely disconnected until commanded to turn back on.

### RELATION TO PRIOR APPLICATIONS

This application claims the benefit of, and priority through, U.S. Provisional Application 62/016,931, titled “Programmable Fuse With Under-voltage/short-circuit Protection,” filed Nov. 25, 2014.

### FIELD OF THE INVENTION

Traditional fuses protect against unwanted voltage and/or current conditions but need to be replaced after blowing, requiring physical access to the blown fuse which may not always be practical. Moreover, changing equipment may require different fuse characteristics as well as opening the system and changing the fuse to match the equipment.

### BACKGROUND

The use of traditional fuses can be an effective means of protecting wiring and/or equipment in a system from voltage and/or current conditions which can damage the wiring and/or equipment. Unfortunately, once the fuse disconnects the faulty equipment in the system by blowing, it must be physically reset and/or replaced. In systems that are difficult to access, the act of replacing the fuse alone can introduce risk to both the operator and the system and incur costly downtime.

An alternative technology to a physically blowable fuse called a resettable fuse can have the benefit of providing trip protection and does not need to be replaced under normal circumstances. However, a resettable fuse does not completely disconnect the faulty equipment and must actually maintain a slight connection or small amount of current to the faulty equipment in order to maintain its protective operation. A complete disconnection of the faulty equipment may be required for critical applications that require no current flow at all. The small amount of current allowed to flow could have detrimental effects on both the operator and the system itself. Over time this small amount of current can lead to corrosion that can ultimately damage the system. If a particular piece of equipment were to disallow the flow of enough current to keep a resettable fuse in its protective state, this type of fuse may continuously cycle on and off leading to possibly undesirable current spikes, not to mention unpredictable behavior of the equipment itself.

Both a traditional fuse and especially a resettable fuse do not have precisely predictable protection behavior. Traditional fuse characteristics are defined by a curve that is created by sample points of a given current and its associated time to blow. Both current and time are typically on a logarithmic scale. A reference to fast or slow blow fuses is defined by the slope or shape of the characteristic curve. At very small time bases of typically less than 1 millisecond, where adiabatic conditions prevail, a melting point or I²T value is given to describe its trip characteristic. Resettable fuses are typically defined by an allowable continuous current and a trip current with one sample current/protection time point. While the traditional fuse defines the curve based on average behavior, both the traditional and resettable fuse also reveal a variance in protection based on temperature. The protection dependence on temperature for a resettable fuse is especially pronounced. In testing of traditional fuses, the actual performance was significantly different than its provided curve, presumably since the curve is based on an average. Since the resettable fuse does not even provide a characteristic curve, the expected protection behavior is widely undefined.

Both types of fuses basically depend on the current through them to activate their protective behavior. The amount of current allowed to flow before the protection occurs can cause the source voltage powering the faulty device to drop significantly. If this source is shared with other working equipment, the voltage drop caused by the faulty equipment can be seen by and negatively affect the working equipment.

If a piece of equipment in the system is changed and its protection requirements are different, either type of fuse would need to be changed to match the new equipment. The same adverse issues of risk and cost to access and change the fuse would apply.

### BRIEF DESCRIPTION OF THE DRAWINGS

The various drawings herein illustrate aspects of the invention described herein.

FIG. 1 is a block diagrammatic schematic view of an exemplary programmable fuse system;

FIG. 2 is a block diagrammatic schematic view of a further exemplary programmable fuse system with a master controller;

FIG. 3 is a block diagrammatic schematic view of an exemplary programmable fuse system with a monitor and equipment;

FIG. 4 is a block view of two exemplary programmable fuse systems with differing fuse configurations; and

FIG. 5 is a set of tables illustrating an exemplary 7 amp fuse characteristic and describes a time frame set from 10 ms to 200 ms for clarity.

### BRIEF DESCRIPTION OF AN EMBODIMENT OF THE INVENTION

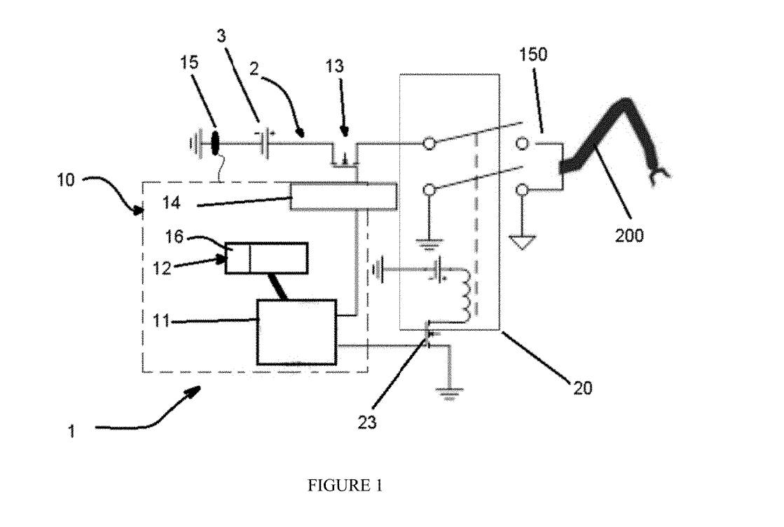

Referring now to FIG. 1, in an embodiment programmable fuse system 1 provides under-voltage/short-circuit protection for a given set of electronic components, e.g. device 150 and/or equipment 200, and comprises one or more electrical circuit sensors 15 operatively in communication with a predetermined set of electrical circuits 2; one or more controllers 10 operatively in communication with electrical circuit sensors 15; and a one or more individual programmable fuses 11 operatively in communication with controller 10 and with the predetermined set of electrical circuits 2. A predetermined subset of individual programmable fuses 11 are operative to completely disconnect a predetermined electrical circuit 2 of the set of electrical circuits 2 on detection of a fault without the need to physically replace programmable fuse 11 and without reliance on any small current to maintain its protection. Elimination of a need for a small current may operate to provide mitigation of corrosion.

Each controller 10 typically comprises active logic 12; memory 16 operatively in communication with active logic 12; and data resident in memory 16. Typically, there is a single controller 10 associated with a single programmable fuse 11.

Electrical circuit sensor 15 may comprise a source voltage sensor and/or a source current sensor operatively in communication with one or more electrical circuits 2 of the set of electrical circuits 2. Although illustrated as being disposed in electrical circuit 2 between solid state switch 13 and ground, electrical circuit sensors 15 may be disposed where and as needed.

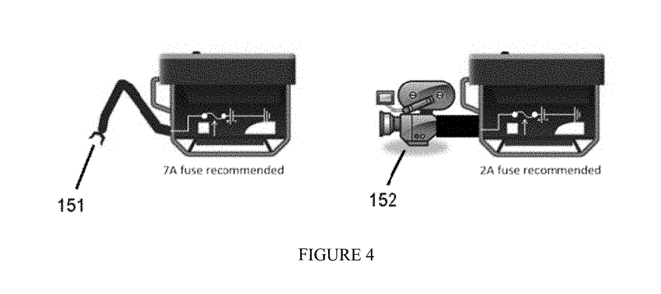

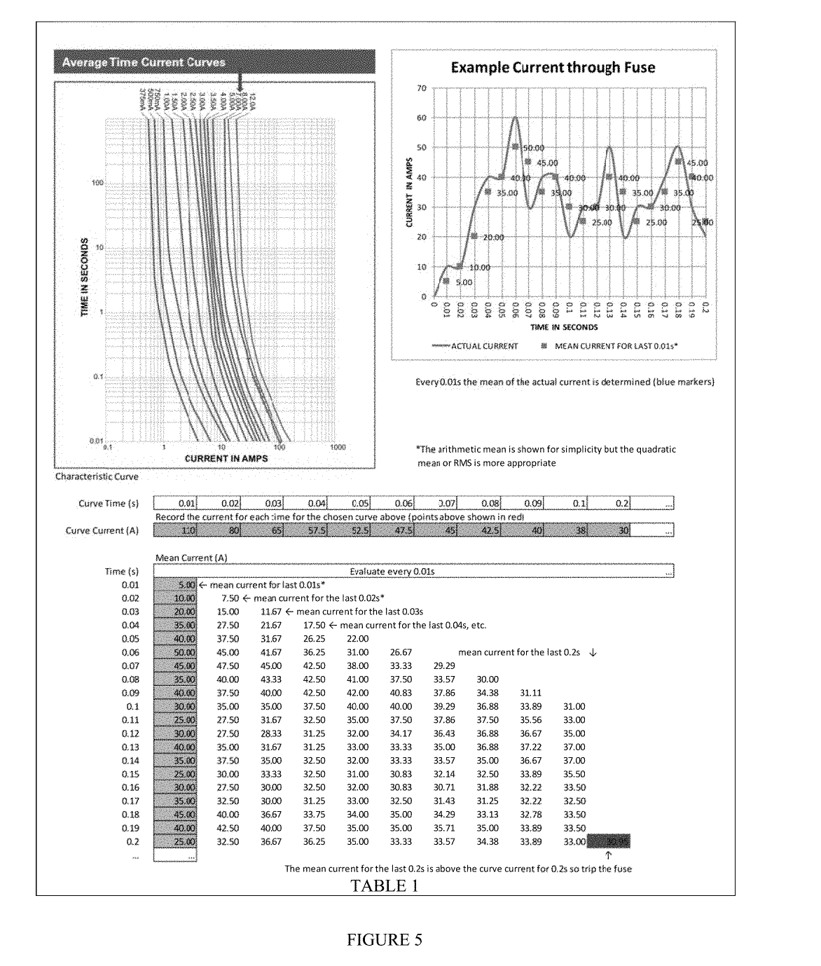

As illustrated in FIG. 4, various pieces of equipment may be connected at varying times to circuit 2, e.g. device 151 and, separately, device 152, each of which may require different operating voltage and/or current characteristics. According, the data resident in memory 16 typically represent, define, or otherwise characterize one or more current/trip time curves and controller 10 used to command programmable fuse 11 to use a specific current/trip time curve of the plurality of several separate current/trip time curves, e.g. one or more such current/trip time curve which match a predetermined piece of equipment or which can be changed if the equipment changes. Table 1 in FIG. 5 illustrates an exemplary 7 amp characteristic and describes a time frame set from 10 ms to 200 ms for clarity. The current illustrated is for current data averaged and logged every 10 ms. In turn, the logged values are shown as averaged over the given time interval of interest and compared to the characteristic table for that given time interval. In practice, logged values may go into a circular buffer and every time interval from 10 ms to 200 ms evaluated every time a value is logged. Although Table 1 is illustrative, a smaller log period, such as 1 ms, may be chosen to characterize fast acting fuses. A log period smaller than 1 ms can be used to capture melting point characteristics of the fuse. It is possible that the power source to the fuse will have its own protection and this protection may occur faster, especially for a hard short circuit condition. In this case, programmable fuse 11 can be used to sense both the current and voltage from a source supply, e.g. 3, during protection and decide whether or not to trip.

In certain embodiments, programmable fuse system 1 further comprises one or more relays 20 operatively in communication with a predetermined set of programmable fuses 11 of the plurality of individual programmable fuses 11 and with a predetermined set of associated devices 150. In these embodiments, each relay 20 may further be operatively connected to solid state switch 13 usually disposed in series with relay 20. If solid state switch 13 is present, one or more electrical circuit sensors 15 may be placed on either or both sides of solid state switch 13. Additionally, one or more switches 23, which may comprise mechanical and/or solid state switches, may be operatively in communication with one or more relays 20. Typically, each programmable fuse 11 has one relay 20 and one switch 23, which are coordinated with each other through individual control of each.

Programmable fuse 11 is typically able to remain completely disconnected until commanded to turn back on, such as by a command issued from controller 10. In FIG. 1, programmable fuse system 1 is illustrated as comprising a single controller 10 in communication with a single programmable fuse 11 where controller 10 controls only one programmable fuse 11.

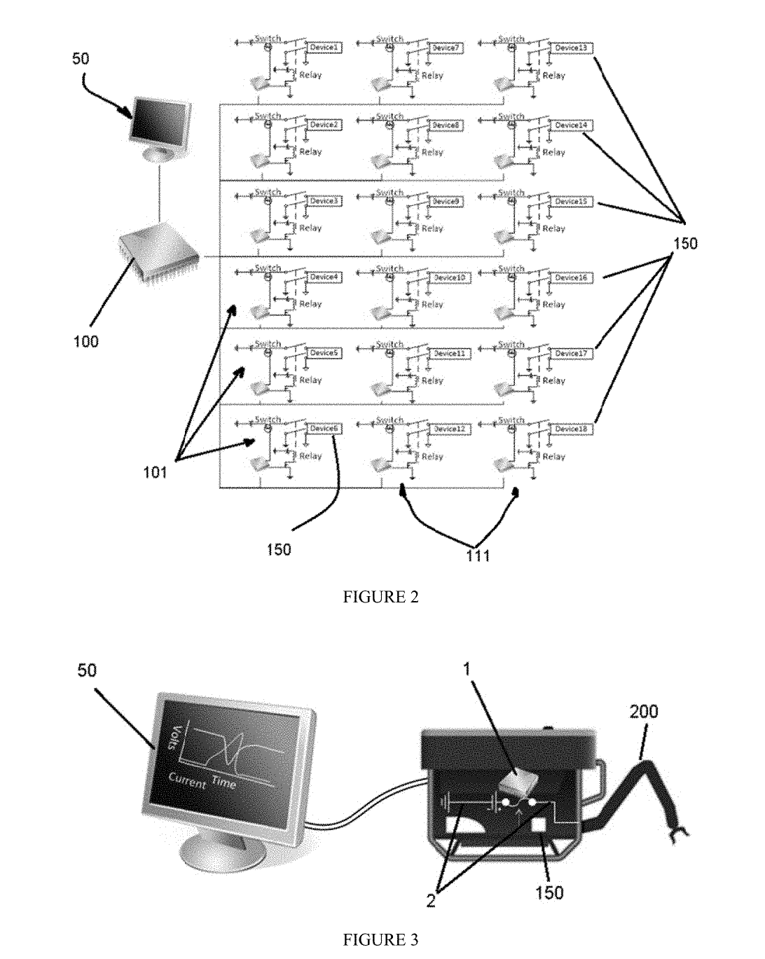

However, referring to FIG. 2, alternative embodiments may comprise a plurality of programmable fuses 11 and master controller 100. As illustrated in FIG. 2, in these other contemplated embodiments master controller 100 may be present and operatively in communication with a plurality of programmable fuse systems 101, each of which may be the same or similar to programmable fuse system 1 discussed above. FIG. 2 only shows several of these called out as “101” and only shows several programmable fuses with callouts of “111” but one of ordinary skill in the electrical arts will recognize that these callouts are merely exemplary. Master controller 100 is operatively in communication with and in at least partial control of individual programmable fuses 111 which are similar to programmable fuse 1 (FIG. 1) where each may individual programmable fuse 111 may include its own controller 10 (FIG. 1). In this further exemplary embodiment master controller 100, which may comprise a microprocessor, serves as a hub for an array of individual programmable fuses 111, e.g. directly or via each such individual programmable fuse 111 controller 10. This arrangement allows multiple devices 150, e.g. equipment, to be served concurrently by programmable fuses 111.

Referring additionally to FIG. 3, in certain embodiments, programmable fuse controller 10 (FIG. 1) and/or master controller 100 (FIG. 2) connects to computer 50, which may be of any appropriate type, which allows concurrent monitoring and control of programmable fuses 11 (FIG. 1) and/or 111 (FIG. 2).

In the operation of exemplary embodiments, programmable fuse system 1 (FIG. 1) has the ability to simulate the protection of a fuse without having to actually replace a fuse when blown and, in embodiments, may be used for multiple devices that connect to programmable fuse system 1. This provides an ability to preclude needing physical replacement of a fuse after it has blown, to change a fuse value on the fly without replacing a fuse, to tailor protection for under-voltage and short-circuit conditions, and to prevent damaging a relay when protecting against current that can exceed the breaking capacity of the relay. As described herein, programmable fuse system 1 may be used to provide the benefits of physical and resettable fuse types and to reduce or eliminate traditional problems associated with both existing technologies.

As described below, programmable fuse system 1 (FIG. 1) may be used to completely disconnect an electrical circuit experiencing a fault without needing to be physically replaced. It does not rely on any small current to maintain its protection and it will remain completely disconnected until commanded to turn back on.

In general, a characteristic current/trip time curve is loaded into a data store of programmable fuse system 1 (FIG. 1), e.g. into memory 16 (FIG. 1), where these data represent curve shapes determined by a programmer. Typically, this programmable characteristic curve represents characteristics that are immune to variations, temperature or otherwise. In embodiments, programmable fuse system 1 can store data representative of several separate curves and can be commanded to use any particular one set of data to match to a particular piece of equipment or be changed if the equipment changes.

As described herein, programmable fuse system 1 (FIG. 1) can sense a source voltage and/or current and trip if voltage and/or current drops too low, exceeds a level, or if it detects a short circuit occurring in order to prevent affecting working equipment that shares the same power source. Typically, in order to completely disconnect from a fault, programmable fuse system 1 opens a traditional relay, e.g. relay 20 (FIG. 1), which have their own set of operational issues that do not reflect the behavior of a fuse tripping. Two particular issues are bounce time and operation/release time upon respective closing/opening, which are not precisely controlled. Another major concern is the breaking capacity of the relay, which is the amount of current allowed to flow through the relay when it opens. If the current is too high, the relay can actually be damaged. Because the nature of a fuse is to open when the current is high, another method is needed to prevent exceeding the breaking capacity of the relay.

An added benefit of having programmable fuse system 1 (FIG. 1) responsible for monitoring its current and source voltage is its ability to report this information along with time to an operator, which may be a human or a separate computer system. This information could be helpful in characterizing the nominal operation of the equipment along with fault analysis in the event that something goes wrong.

The basic idea of how programmable fuse system 1 (FIG. 1) may evaluate its trip characteristic against actual events is illustrated in Table 1, above. The exemplary table was generated for a particular 7 amp fuse characteristic and described only from 10 ms to 200 ms for clarity. The current is averaged every 10 ms and logged. These logged values are in turn averaged over the given time interval of interest and compared to the characteristic table for that given time interval. The logged values go into a circular buffer and every time interval from 10 ms to 200 ms is evaluated every time a value is logged. A smaller log period, such as 1 ms, may be chosen to characterize fast acting fuses. A log period smaller than 1 ms may be used to capture melting point characteristics of a fuse. It is also possible that a power source operatively in communication with to programmable fuse system 1 (FIG. 1) will have its own protection and this protection may occur faster, especially for a hard short circuit condition. In this case, programmable fuse system 1 can be used to sense current, voltage, or both from the source supply during protection and decide whether or not to trip.

Other basic fusing technologies could be used with some programmable means of selecting different values. By way of example and not limitation, a peak trip limit could be employed that does not necessarily follow a fuse but provides protection. Basic under-voltage lockout or short circuit technology may also be employed though it might not be programmable.

Referring back to FIG. 1, circuit protection may be provided by operatively placing one or more programmable fuse systems 1 in communication with a set of electrical circuits 2, where programming fuse system 1 is as described above, to aid with controlling device 150 and equipment 200. One or more electrical circuit sensors 15 may be used to monitor a predetermined set of electrical characteristics of the set of electrical circuits 2. Upon detection of a fault in an electrical circuit 2 of the set of electrical circuits 2, controller 10 determines if the fault requires a disconnect command based on the characteristic current/trip time curves.

When a disconnect situation is encountered, an appropriate programmable fuse 11 is tripped, i.e. opened, such as if sensed voltage indicates a short circuit. Typically, if a disconnect command is to be sent, controller 10 sends a command to a predetermined programmable fuse 11 of the plurality of individual programmable fuses 11 that is operatively in electrical circuit 2 with the fault to completely disconnect that electrical circuit 2 without the need to physically replace programmable fuse 11 and without reliance on any small current to maintain circuit protection. If such a disconnect command is sent, electrical circuit 2 with the fault may then be kept completely disconnected until controller 10 issues a command to that programmable fuse 11 operatively in the electrical circuit 2 with the fault to reestablish electrical continuity in the electrical circuit 2 with the fault. It is understood that all such commands may be generated by each controller 10 independently or under the control, whether exclusive or cooperative, of master controller 100 (FIG. 2).

The disconnect command may be sent at any time, including independently of a fault detection. Such disconnect commands may be operative to disconnect electrical circuit 2.

Controller 10 typically uses data resident in memory 16, the data representing one or more characteristic current/trip time curves, to determine if and when to issue a command to a programmable fuse 11 operatively in electrical circuit 2 with the fault to completely disconnect that electrical circuit 2. As noted above, these data may comprise data representative of protection tailored for an under-voltage and/or a short-circuit condition. By way of example and not limitation, the data resident in the memory may also represent a set of characteristic current/trip time curves, where curves are used to trip if current goes too high, with data operative to trip a programmable fuse if sensed voltage drops too low in order to prevent affecting working equipment that shares the same source voltage. It is noted that a voltage drop setting is typically separate from current/trip time curves.

In certain embodiments, data resident in memory 16 may be changed dynamically such as via computer 50 (FIG. 3), either with or without human intervention, such as by sending data to controller 10 and issuing a command to controller 10 to update data in memory 16. In typical embodiments, a collection of curves are stored in memory 16. Master controller 100, which is controlled by computer 50, may comprise a user interface used to send instructions to programmable fuse system 1 as to which curve to use out of its collection of stored curves. On other embodiments, the curves could also be altered by reprogramming programmable fuses 11 directly, e.g. via direct access to programmable fuse 11.

Further, a history of monitored current and source voltage may be accumulated by controller 10 and/or master controller 100 (FIG. 2), where the history may comprise a time of the accumulation. This history may be reported to an operator or software in a different system such as via computer 50 (FIG. 3).

As noted above, and referring still to FIG. 1, in certain embodiments programmable fuse system 1 further comprises one or more relays 20 operatively in communication with a predetermined subset of the plurality of individual programmable fuses 11, where each relay 20 may further be in communication with solid state switch 23 placed in series with relay 20. Where relay 20 is provided, solid state switch 13 and/or solid state switch 23 do not necessarily have the ability to completely disconnect the fault, i.e. some small amount of current may still allowed to flow. However, solid state switch 13 and/or solid state switch 23 do not have bounce issues and typically do not require consideration for breaking capacity. Furthermore, the close/open or on/off time for solid state switch 13 and/or solid state switch 23 is much more precise. Typically, one or both of solid state switch 13 and/or solid state switch 23 may be commanded to open first to break the high current in a precise manner. Once the high current is diminished, relay 20 will then open to allow a complete disconnection from the fault. To prevent bounce on closing, relay 20 may be turned on first followed by one or both of solid state switch 13 and/or solid state switch 23.

In reality some amount of breaking current is actually recommended for a relay during its lifetime. The act of breaking current on a relay can clean oxidation from its contacts, ensuring better conductivity when it is closed. Programmable fuse system 1, therefore, may be programmed to periodically open relay 20 before one or both of solid state switch 13 and/or solid state switch 23. Typically, this occurs only if the breaking current is below the breaking capacity specification for relay 20. In preferred embodiments, relay 20 and solid state switch 23 operate in conjunction and cannot operate independently. In these embodiments, relay 20 can operate before solid state switch 13.

In various embodiments, data in the set of data may further comprise data sufficient to accommodate preventing damaging relay 20 when protecting against current that can exceed the breaking capacity of relay 20. In various embodiments, the predetermined breaking capacity of relay 2 is known. Once a switch, e.g. switch 13, is closed, then relay 20 is closed, allowing current to flow which can be measured. When programmable fuse 11 is tripped or otherwise opened, switch 13 is typically opened first because, as opposed to relay 20, switch 13 does not have a current limit for opening.

Occasionally, relay 20 may be opened first to allow a spark and de-oxidation of the relay contacts. Accordingly, the current may be checked first to make sure it does not exceed the breaking capacity of relay 20 before allowing relay 20 to open before switch 13.

In various embodiments, electrical circuit sensor 15 may be used to sense current in electrical circuit 2 and, if the sensed current is below the breaking capacity specification for relay 20 in communication with electrical circuit 2, controller 10, at a predetermined set of times such as are represented by data in memory 16, issues a command to open that relay 20 before its associated solid state switch 23. In these embodiments, electrical circuit sensor 15 may also be used to sense current in electrical circuit 2 and solid state switch 13 and/or solid state switch 23 opened first to break a detected high current in a precise manner, although switch 23 would not be opened first since this is the switch that operates relay 20. Switch 13 would open first, then the relay. Once the high current is diminished, relay 20 may be opened to allow a complete disconnection from the fault. It is noted that this sequencing may operate to extend the useful life of relay 20 such as by having its contacts de-oxidized by electrical arcing.

If relay 20 is present, electrical continuity may be restored by issuing a command from controller 10 to relay 20 to reenergize relay 20. Relay bounce may be ameliorated or even eliminated on restoring electrical continuity by turning relay 20 on first followed by solid state switch 13.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. A programmable fuse system with under-voltage/short-circuit protection, comprising:
a. an electrical circuit sensor operatively in communication with a predetermined set of electrical circuits;
b. a controller operatively in communication with the electrical circuit sensor, comprising:
i. active logic;
ii. a memory operatively in communication with the active logic; and
iii. data resident in the memory, the data representing a set of characteristic current/trip time curves; and
c. a programmable fuse operatively in communication with the controller and with the predetermined set of electrical circuits, the programmable fuse operative to completely disconnect a predetermined electrical circuit of the set of electrical circuits on detection of a fault, without the need to replace a programmable fuse and without reliance on any small current to maintain its protection, and to remain completely disconnected until commanded to turn back on.

2. The programmable fuse of claim 1, further comprising:
a. a relay operatively in communication with the programmable fuse; and
b. a solid state switch operatively in series with the relay.

3. The programmable fuse of claim 1, wherein the data representing a characteristic current/trip time curve further comprise data representing a plurality of several separate current/trip time curves.

4. The programmable fuse of claim 3, wherein the programmable fuse can be commanded to use a predetermined current/trip time curve of the plurality of several separate current/trip time curves which matches a predetermined piece of equipment.

5. The programmable fuse of claim 1, wherein the electrical circuit sensor comprises a source voltage sensor operatively in communication with an electrical circuit of the set of electrical circuits.

6. The programmable fuse of claim 1, wherein the electrical circuit sensor comprises a source current sensor operatively in communication with an electrical circuit of the set of electrical circuits.

7. A method of providing circuit protection, comprising:
a. operatively placing a programmable fuse system into a set of electrical circuits, the programming fuse system comprising:
i. an electrical circuit sensor operatively in communication with a predetermined set of electrical circuits;
ii. a controller operatively in communication with the electrical circuit sensor, comprising:
1. active logic;
2. a memory operatively in communication with the active logic; and
3. data resident in the memory, the data representing a set of characteristic current/trip time curves;
4. a programmable fuse operatively in communication with the controller and with the predetermined set of electrical circuits, the programmable fuse operative to completely disconnect a predetermined electrical circuit of the set of electrical circuits on detection of a fault without the need to replace a programmable fuse and without reliance on any small current to maintain its protection, and to remain completely disconnected until commanded to turn back on;
b. using the electrical circuit sensor to monitor a predetermined set of electrical characteristics of the set of electrical circuits;
c. upon detection of a fault in an electrical circuit of the set of electrical circuits:
i. determining if the fault requires a disconnect command based on the characteristic current/trip time curves; and
ii. if a disconnect command is to be sent, sending a command from the controller to the programmable fuse that is operatively in the electrical circuit with the fault to completely disconnect the electrical circuit with the fault without the need to replace the programmable fuse and without reliance on any small current to maintain circuit protection; and
d. keeping the electrical circuit with the fault completely disconnected until the controller issues a command to the programmable fuse operatively in the electrical circuit with the fault to reestablish electrical continuity in the electrical circuit with the fault.

8. The method of claim 7, further comprising having the controller use data resident in the memory, the data representing a characteristic current/trip time curve, to determine when to issue the command to the programmable fuse operatively in the electrical circuit with the fault to completely disconnect the electrical circuit with the fault.

9. The method of claim 8, further comprising allowing dynamic changing of the data resident in the memory.

10. The method of claim 7, wherein the data resident in the memory further comprise data representative of protection tailored for an under-voltage and/or a short-circuit condition.

11. The method of claim 7, wherein the programmable fuse system further comprises a relay operatively in communication with the programmable fuse and a solid state switch in series with the relay, the method further comprising providing data in the set of data to accommodate preventing damaging the relay when protecting against current that can exceed the breaking capacity of the relay.

12. The method of claim 11, wherein the electrical circuit sensor comprises a current sensor, the method further comprising:
a. using the electrical circuit sensor to sense current in an electrical circuit of the predetermined set of electrical circuits; and
b. if the sensed current is below the relay's breaking capacity specification, having the controller, at a predetermined set of times, issue a command to open the relay before the switch.

13. The method of claim 12, wherein issuing the command to open the relay before the switch is operative to de-oxidize contacts of the relay.

14. The method of claim 11, further comprising:
a. using the electrical circuit sensor to sense current in an electrical circuit of the predetermined set of electrical circuits;
b. opening the solid state switch first to break a detected high current in a precise manner; and
c. once the high current is diminished, opening the relay to allow a complete disconnection from the fault.

15. The method of claim 11, further comprising:
a. restoring electrical continuity by issuing a command from the controller to the relay to reenergize the relay; and
b. preventing bounce on restoring electrical continuity by turning the relay on first followed by the switch.

16. The method of claim 7, further comprising providing the data resident in the memory which represents the set of characteristic current/trip time curves with data operative to trip a programmable fuse if sensed voltage drops too low in order to prevent affecting working equipment that shares the same source voltage.

17. The method of claim 7, further comprising tripping a programmable fuse if sensed voltage indicates a short circuit.

18. The method of claim 7, further comprising:
a. accumulating a history of monitored current and source voltage by the controller, the history comprising a time of the accumulation; and
b. reporting the history to an operator.

19. The method of claim 7, where the disconnect command may be sent at any time, including independently of a fault detection.
